(19) United States
(12) Patent Application Publication
(10) Pub. No.: US 2005/0053831 A1
(43) Pub. Date: Mar. 10, 2005

(54) Battery pack

(76) Inventors: Steffen Katzenberger, Bad Liebenzell (DE); Wolf Matthias, Stuttgart (DE)

Correspondence Address: STRIKER, STRIKER & STENBY, 103 EAST NECK ROAD, HUNTINGTON, NY, 11743, US

(21) Appl. No.: 10/931,599

(22) Filed: Sep. 1, 2004

(30) Foreign Application Priority Data
Sep. 5, 2003 (DE) 103 40 973.4

(51) Int. Cl. H01M 10/42

(52) U.S. Cl. 429/149; 429/48

(57) ABSTRACT

A battery pack for battery-operated hand power tools has a housing, a plurality of battery cells arranged in the housing and containing an electrolyte, a material arranged in the housing and capable of absorbing the electrolyte which escapes from the battery cells, the material being a material which chemically reacts with the electrolyte or parts of the electrolyte to form one or several such compounds which substantially are not damaging for humans and/or environment.

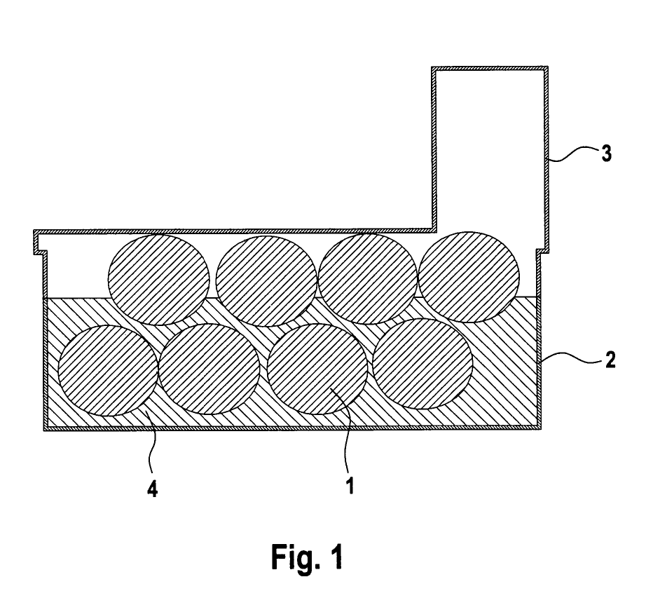

### BACKGROUND OF THE INVENTION

The present invention relates to a battery pack, in particular for battery-operated hand power tools.

More particularly, it relates to such a battery pack which is composed of several battery cells arranged in a housing and containing an electrolyte, wherein in the housing a material is introduced, that can absorb the electrolyte exiting the battery cells.

When very high currents flow in a battery pack, as for example occurs during a short circuiting, a very intense heating of the battery cells in the pack occurs. As a result of this intense heating, the electrolyte located in the battery cells can exit escape from the individual battery cells and finally escape from the battery pack. Depending on a type of the battery cells, the electrolyte or its components are damaging. In the frequently used battery cells of nickel with a base (NiCd, NiMH) the electrolyte contains as a main part potassium alkaline solution. Thereby there is a danger that a person who is in contact with the battery pack experiences calcification on the skin and on the eyes. Other electrolytes are easily inflammable or carcenogenous or contain health damaging and/or environment damaging agents.

U.S. Pat. No. 5,399,445 describes an indicator function that makes visible an escape of the electrolyte from the battery pack. In particular, the electrolyte is absorbed by a fiber material introduced in the battery pack and then a color reaction with the fiber material occurs. Despite absorption of the electrolyte by the fiber material, the electrolyte can escape from the housing of the storage battery pack, which as a rule is not tight and therefore represents an injury risk for an operator.

### SUMMARY OF THE INVENTION

Accordingly, it is an object of the present invention to provide a battery pack of the above mentioned general type, which avoids the disadvantages of the prior art.

More particularly, it is an object of the present invention to provide a battery pack of the above mentioned general type, in which the danger that an operator can be injured by an electrolyte escaping from the housing is substantially excluded.

In keeping with these objects and with others which will become apparent hereinafter, one feature of the present invention resides, briefly stated, in a battery pack for battery-operated hand power tools, comprising a housing; a plurality of battery cells arranged in said housing and containing an electrolyte; a material arranged in said housing and capable of absorbing the electrolyte which escapes from said battery cells, said material being a material which chemically reacts with the electrolyte or parts of the electrolyte to form one or several such compounds which substantially are not damaging for humans and/or environment.

When the battery pack is designed in accordance with the present invention it eliminates the disadvantages of the prior art, and provides for the above mentioned highly advantageous results.

In accordance with another feature of present invention, in the battery pack in accordance with the present invention, said material is a material which has a structure selected from the group consisting of a cellulose, a fibrous matter, a wool, a granulate, and a powder.

In accordance with still a further feature of the present invention, in the battery pack said material has functional groups, such as acetate groups or carbonate groups.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

A single FIGURE of the drawings is a view showing a cross-section through a battery pack in accordance with the present invention, in which a material absorbing an electrolyte is introduced in the battery pack.

### DESCRIPTION OF THE PREFERRED EMBODIMENTS

A battery pack in accordance with the present invention is shown in the drawings. It has a housing in which a plurality of battery cells 1 are arranged.

The battery housing is composed of a lower housing part 2 and an upper housing part 3. The upper housing part 3 contains, in a conventional manner (not shown in the drawings), contact devices that provide electrical connection between the battery cells 1 and a motor drive in a battery-operated electrical device, for example an electrical hand power tool. The battery cells 1 are filled with an electrolyte as well known in the art.

When in the battery cells a very high current flows, which for example is the case during a short circuiting, the battery cells in the battery pack are heated intensely. As a result of this heating, an escape of the electrolyte from the battery cells can occur. When a corresponding high inner pressure acts in the housing of the battery pack, the electrolyte can escape from the housing 2, 3 of the battery pack through untight locations in the housing outwardly.

Since the electrolyte contains for example potassium alkaline solution, there is a danger that an operator of the battery-operated electrical device will experience calcification on the skin or in the worse case also on the eyes.

In the battery pack, a material 4 is introduced in the housing 2, 3, which is capable of absorbing the electrolyte escaping from the battery cells 1. This material 4 can be for example composed of a cellulose or a fibrous structure or a wool or a granulate or a powder. Even when this material absorbs the electrolyte escaping from the battery cells, it is not possible to completely avoid that the electrolyte in flowable form or as gas escapes from untight locations of the housings 2, 3.

For making sure that in this case the electrolyte does not present any health-damaging consequences for an operator of the battery-operated electrical device and/or the environment, a material 4 is selected so that it chemically reacts with the electrolyte or parts of the electrolyte to form one or several such compounds, which do not cause damaging action for humans and/or the environment. One of such materials 4 which satisfies this requirement is cellulose acetate.

When the solution of the electrolyte comes in contact with the acetate groups of the cellulose acetate in the battery pack, these acetate groups react chemically with the solution of the electrolyte so that a basic catalytic hydrolysis of the acetate to cellulose and acetic acid is performed. As a result of this first chemical reaction, further following reactions take place, in which the cellulose under the action of the solution is converted to sugar and the acetic acid reacts to an acetate. By the thusly proceeding chemical reactions, a chemical neutralization of the potassium alkaline solution is provided.

Due to the simultaneous availability of acetic acid and acetate ions, a stabilization of the pH value in the vicinity of the neutral point (pH 7), or a so-called acetic acid-acetate buffer is provided. These compositions are no longer dangerous when they exit from the housing 2, 3 of the battery pack.

For binding organic electrolytes, which can lead to a respiratory irritations or which are easily inflammable or explosive, the carrying material can be functionalized for example olefine groups. For the use in lead batteries, the carrier material can be functionalized with basic groups for example carbonate groups.

It will be understood that each of the elements described above, or two or more together, may also find a useful application in other types of constructions differing from the types described above.

While the invention has been illustrated and described as embodied in a battery pack, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A battery pack for battery-operated hand power tools, comprising a housing; a plurality of battery cells arranged in said housing and containing an electrolyte; a material arranged in said housing and capable of absorbing the electrolyte which escapes from said battery cells, said material being a material which chemically reacts with the electrolyte or parts of the electrolyte to form one or several such compounds which substantially are not damaging for humans and/or environment.

2. A battery pack as defined in claim 1, wherein said material is a material which has a structure selected from the group consisting of a cellulose, a fibrous matter, a wool, a granulate, and a powder.

3. A battery pack as defined in claim 1, wherein said material has functional groups.

4. A battery pack as defined in claim 1, wherein said functional groups are groups selected from the groups consisting of acetate groups and carbonate groups.
